(19) United States
(12) Patent Application Publication
(10) Pub. No.: US 2020/0270444 A1
(43) Pub. Date: Aug. 27, 2020

(54) OPTICAL LENS COMPOSITION AND MANUFACTURING METHOD OF OPTICAL LENS

(71) Applicant: TAI TWUN ENTERPRISE CO., LTD., NEW TAIPEI CITY (TW)

(72) Inventor: Le-Yao LIN, NEW TAIPEI CITY (TW)

(21) Appl. No.: 16/564,571

(22) Filed: Sep. 9, 2019

(30) Foreign Application Priority Data
Feb. 22, 2019 (TW) 108105927

(51) Int. Cl. C08L 47/00; C09K 9/02; G02B 1/04

(52) U.S. Cl. CPC C08L 47/00; B29D 11/00009; G02B 1/041; C09K 9/02

(57) ABSTRACT

An optical lens composition and a manufacturing method of an optical lens are provided. The manufacturing method of the optical lens includes molding an optical lens composition by injection molding, and the optical lens composition including a polymer mixture and a functional material; wherein the polymer mixture includes a styrene-butadiene copolymer.

### CROSS-REFERENCE TO RELATED APPLICATION

This application claims priority from Taiwan Patent Application No. 108105927, filed on Feb. 22, 2019, in the Taiwan Intellectual Property Office, the content of which is hereby incorporated by reference in its entirety for all purposes.

### BACKGROUND OF THE INVENTION

### 1. Field of the Invention

The present invention relates to an optical lens composition and a manufacturing method of an optical lens, more particularly to an optical lens composition including a styrene-butadiene copolymer and a manufacturing method of molding the optical lens composition as an optical lens by injection molding.

### 2. Description of the Related Art

Optical lenses may be applied to various fields and used for daily supplies such as glasses and helmet goggles, outdoor equipment such as snow glasses and swimming goggles, electronic products such as display screens and light filters, or vehicle equipment such as windshields. To perform well in a variety of environments, the optical lenses may have corresponding functional requirements such as discoloration, anti-fogging, hardening, and scratch resistance.

Currently, the main manufacturing method of commercially available optical lenses is a method that disposes a functional material having special functions on the lens by using immersion plating, sputtered coating, evaporation depositing, or the like after molding a lens material and obtaining lenses without special functions. However, the aforementioned manufacturing method may be affected by some problems, such as uneven coating, the coated functional material possibly being abraded during use, complicated manufacturing processes of producing optical lenses with multiple functions, and costs stemming from environmental concerns regarding wastewater and waste gas.

Hence, there is still a need for an optical lens composition and a manufacturing method of an optical lens with a low cost for the manufacturing process and multi-functionality.

### SUMMARY OF THE INVENTION

In view of the aforementioned problems, the present invention aims to provide an optical lens composition including a styrene-butadiene copolymer (polybutadiene-styrene, PBS) and provide a manufacturing method of molding an optical lens composition including the styrene-butadiene copolymer to an optical lens only by an one-step injection molding method. Therefore, fluxing and granulating may be directly performed to the polymer material and the required functional material. Afterward, optical lenses with the required functions may be obtained through the injection molding.

According to the purpose of the present invention, a manufacturing method of an optical lens is provided, including molding an optical lens composition by injection molding, and the optical lens composition including a polymer mixture; and a functional material; wherein the polymer mixture includes a styrene-butadiene copolymer.

Optionally, the styrene-butadiene copolymer accounts for at least 50 wt % of the total weight of the polymer mixture.

Optionally, a weight ratio of styrene to butadiene of the styrene-butadiene copolymer is 30-65: 25-50.

Optionally, the functional material includes a photochromic material, an anti-fogging material, a hardening material, or a combination thereof.

Optionally, when the functional material includes the photochromic material, a weight ratio of the polymer mixture to the photochromic material is 1000:0.01-50.

Optionally, when the functional material includes the anti-fogging material, a weight ratio of the polymer mixture to the anti-fogging material is 1000:10-200.

Optionally, when the functional material includes the hardening material, a weight ratio of the polymer mixture to the hardening material is 1000:10-200.

According to the other purpose of the present invention, an optical lens composition is provided, including a polymer mixture; and a functional material; wherein the polymer mixture includes a styrene-butadiene copolymer.

The optical lens composition and the manufacturing method of the optical lens of the present invention have the following advantages:

(1) In the manufacturing method of an optical lens of the present invention, fluxing and granulating are performed to the polymer mixture including the styrene-butadiene copolymer to obtain an optical lens composition. Furthermore, the optical lens may be molded only by an one-step injection molding method. Compared to conventional lenses using poly(methyl methacrylate)(PMMA) and polycarbonate(PC) as main materials, the optical lens of the present invention using the styrene-butadiene copolymer as the main material has excellent surface hardness, surface glossiness, and transparency. In addition, the temperature of injection molding of polycarbonate is 280° C., and the temperature of injection molding of the styrene-butadiene copolymer is only about 200° C. Therefore, the manufacturing method of the optical lens of the present invention has the advantages of the lower temperature of injection molding required, and thereby reducing manufacturing costs.

(2) In the manufacturing method of the optical lens of the present invention, various functional materials may be further added according to requirements, such as a photochromic material, an anti-fogging material, a hardening material, and the like. Fluxing and granulating may be directly performed to the required functional material and the polymer mixture including the styrene-butadiene copolymer. Afterward, an optical lens may be molded only by an one-step injection molding method. Therefore, compared to conventional techniques disposing all of the functional materials on the optical lens layer by layer, such as immersion plating, sputtering, and evaporation, the manufacturing method of the optical lens of the present invention has some advantages, such as simple manufacturing processes, low costs, suitability for mass production, and no need to change the original factory equipment.

(3) In the optical lens obtained by the optical lens composition and manufacturing method of the optical lens of the present invention, since the photochromic material is evenly distributed in the polymer mixture, the entirely optical lens may exhibit an even color. Moreover, since the particle diameters of both the hardening material and the anti-fogging material are much smaller than the particle diameter of the polymer mixture, the hardening material and the anti-fogging material may be assembled on the surface of the optical lens base on intermolecular force in addition to being distributed in the entirely optical lens. Thus, the surface of the optical lens may effectively exhibit the effects of hardening and anti-fogging.

(4) Since the optical lens composition of the present invention uses the functional materials, such as the photochromic material, the anti-fogging material, and the hardening material as additives, and adds them into the polymer mixture for fluxing and granulating. Therefore, the functional effect obtained by correspondingly adding the additives maintains a long period with wide applications.

### BRIEF DESCRIPTION OF THE DRAWINGS

FIG. 1 depicts a flowchart of the manufacturing method of the optical lens according to the present invention.

FIG. 2 depicts an actual view of the optical lens obtained by an example of the manufacturing method of the optical lens according to the present invention.

FIG. 3 depicts a light penetration spectrogram of an example of the manufacturing method of the optical lens according to the present invention.

FIG. 4 depicts a time-maintaining analytical graph of an example of the manufacturing method of the optical lens according to the present invention.

FIG. 5 depicts an anti-fogging test image of an example of the manufacturing method of the optical lens according to the present invention.

### DESCRIPTION OF THE PREFERRED EMBODIMENTS

To make the aforementioned purposes, the technical features, and the gains after actual implementation more obvious and understandable to a person of ordinary skill in the art, the following description shall be described in more detail with reference to the preferable embodiment together with related drawings.

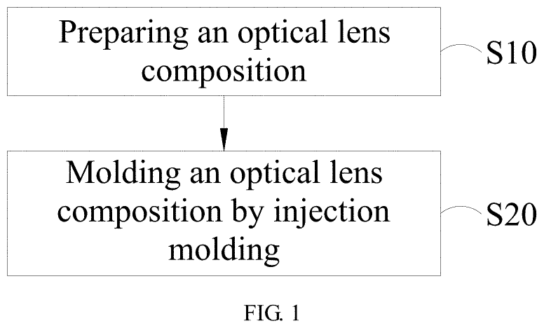

Please refer to FIG. 1, which depicts a flowchart of the manufacturing method of the optical lens according to the present invention.

In step S10, an optical lens composition is prepared. The optical lens composition includes a polymer mixture and a functional material, wherein the polymer mixture includes a styrene-butadiene copolymer. The polymer mixture may include an assistant, a plasticizer, a dispersant, an adhesive, or a combination thereof.

In one embodiment, the styrene-butadiene copolymer accounts for at least 50 wt % of the total weight of the polymer mixture, preferably at least 75 wt %, more preferably at least 85 wt %.

In one embodiment, a weight ratio of styrene to butadiene of the styrene-butadiene copolymer is 30-65: 25-50, preferably 45-60: 28-45, more preferably 50-58: 30-41. The molecular weight of the styrene-butadiene copolymer may be 8000-40000, preferably 10000 to 35000, more preferably 29000-30000. The styrene-butadiene copolymer may be the copolymer including a styrene monomeric unit, a 1,3-butadiene monomeric unit, an ethylbenzene monomeric unit, or any combination thereof. The styrene-butadiene copolymer may be the butylbenzene transparent anti-impact resin, such as K-resin®.

In one embodiment, the functional material may include a photochromic material, an anti-fogging material, a hardening material, or a combination thereof, or may include a functional material known to a person of ordinary skill in the art. For instance, the functional material may further include anti-abrading materials, anti-static materials, anti-blue-light materials, anti-corrosion materials, and the like.

In one embodiment, the photochromic material may include an photochromic toner, a light stabilizer, and/or an antioxidant. The photochromic material may include melamine formaldehyde resin, octahydrooxyoctanoic acid, or trioctanoin. The photochromic material may further include general dyes without photochromic properties. The weight of the light stabilizer and the antioxidant is 0.5 to 5 times than that of the photochromic toner. The weight ratio of the photochromic toner to the light stabilizer is 0-20: 1-7, preferably 0-10: 2-5.

In one embodiment, the anti-fogging material may include an internal anti-fogging agent or a conventional anti-fogging material known to a person of ordinary skill in the art. The anti-fogging material may include a polyol-type non-ionic surfactant, and the polyol-type non-ionic surfactant may include glycerol ester, polyglycerol ester, sorbitan ester, ethoxylated derivative, ethoxylated nonylphenol, ethoxylated alcohol, or a combination thereof.

In one embodiment, the hardening material may include a nano-material with organic-inorganic hybridization or a conventional hardening material known to a person of ordinary skill in the art. The nano-material with organic-inorganic hybridization may include an organic decane coupling agent, nano silicon oxide, nano metal oxide, adhesion resin, and a solvent, wherein the solvent includes water, alcohol, ketone, and/or ester. In one embodiment, the hardening material may include polytetrafluoroethylene (PTFE).

In one embodiment, the optical lens molded by the optical lens composition of the present invention may be further applied with an external anti-fogging agent through spray coating, impregnation, sputtering, evaporation, and deposition, and thereby improving the anti-fogging effect of the optical lens.

In one embodiment, the aspect of the optical lens composition of the present invention is shown in Table 1, wherein the values in Table 1 are all by weight. For instance, the weight units may be grams (g), kilograms (Kg), or metric tons (T) according to requirements.

TABLE 1

| | Polymer | Photochromic | Anti-fogging | Hardening |
|---|---|---|---|---|
| Aspect | mixture | material | material | material |
| Aspect 1 | 1000 | 0.01-50 | X | X |
| Aspect 2 | 1000 | X | 10-200 | X |
| Aspect 3 | 1000 | X | X | 10-200 |
| Aspect 4 | 1000 | 0.01-50 | 10-200 | X |
| Aspect 5 | 1000 | 0.01-50 | X | 10-200 |
| Aspect 6 | 1000 | X | 10-200 | 10-200 |
| Aspect 7 | 1000 | 0.01-50 | 10-200 | 10-200 |

X refers to no addition.

In Aspect 1, the weight ratio of the polymer mixture to the photochromic material is 1000:0.01-50, preferably 1000:0.01-35.

In Aspect 2, the weight ratio of the polymer mixture to the anti-fogging material is 1000:10-200, preferably 1000:80-120.

In Aspect 3, the weight ratio of the polymer mixture to the hardening material is 1000:10-200, preferably 1000:95-180.

In Aspect 4, the weight ratio of the polymer mixture, the photochromic material, and the anti-fogging material is 1000:0.01-50:10-200, preferably 1000:0.01-35:80-120.

In Aspect 5, the weight ratio of the polymer mixture, the photochromic material, and the hardening material is 1000:0.01-50:10-200, preferably 1000:0.01-35:95-180.

In Aspect 6, the weight ratio of the polymer mixture, the anti-fogging material, and the hardening material is 1000:10-200:10-200, preferably 1000:80-120:95-180.

In Aspect 7, the weight ratio of the polymer mixture, the photochromic material, the anti-fogging material, and the hardening material is 1000:0.01-50:10-200:10-200, preferably 1000:0.01-35:80-120:95-180.

In step S20, the optical lens composition is molded by injection molding to obtain an optical lens.

The injection molding methods may include single-screw fluxing, sub-parent fluxing, twin-screw fluxing, continuous fluxing, or a conventional injection molding method known to a person of ordinary skill in the art. In one embodiment, the process of the injection molding method may be a single-screw fluxing, and the temperature may be 120 to 210° C., preferably 150 to 200° C., more preferably 170 to 190° C.

In one embodiment, the manufacturing method of the optical lens of the present invention may further include conventional pre- or post-processing steps known to a person of ordinary skill in the art, such as polishing.

Exemplary illustrations and analysis of each aspect of the present invention are described using the examples below. For ease of description, the following analysis is performed respectively on the photochromic test, the anti-fogging test, and the hardening test only.

Photochromic Test

The compositions and analytical results of Examples 1 to 4 and the comparative example of Aspect 1 are shown in Table 2. Wherein, Example 1 is an optical lens formed of composition including 1000 g of the polymer mixture without any photochromic material and directly molded with injection molding at 150° C. Examples 2 to 4 are optical lenses formed of compositions including 1000 g of the polymer mixture and respectively including 0.6 g, 1 g, and 3 g of the red photochromic material and molded with injection molding at 190° C. Wherein, the polymer mixture includes the styrene-butadiene copolymer which accounts for 89 wt % of the total weight of the polymer mixture. The weight ratio of styrene to butadiene of the styrene-butadiene copolymer is 57:32. The color concentration is measured by a spectrometer in the step of the diffraction grating.

TABLE 2

| | Compositions | | |
|---|---|---|---|
| | polymer | photochromic | |
| Aspect 1 | mixture | material | Results |
| Example 1 | 1000 g | X | No change in colors |
| Example 2 | 1000 g | 0.6 g | Color concentration 30 |
| Example 3 | 1000 g | 1 g | Color concentration 50 |
| Example 4 | 1000 g | 3 g | Color concentration 70 |

| | | |
|---|---|---|
| Comparative example | Polycarbonate | Color concentration 70 |
| (Commercially | discoloration lens | |
| available products) | processed by | |
| | immersion plating | |

X refers to no addition.

As shown in Table 2, it is known that the color concentration of the optical lens obtained from the manufacturing method of the optical lens of the present invention may be adjusted according to the weight of the added photochromic material, and the optical lens indeed has the effect of discoloration. Moreover, color concentrations of Example 3 and Example 4 are equal to the color concentrations of commercially available products obtained by immersion plating, which means that the manufacturing method of the optical lens of the present invention may manufacture an optical lens which indeed has a photochromic effect by a simple manufacturing process.

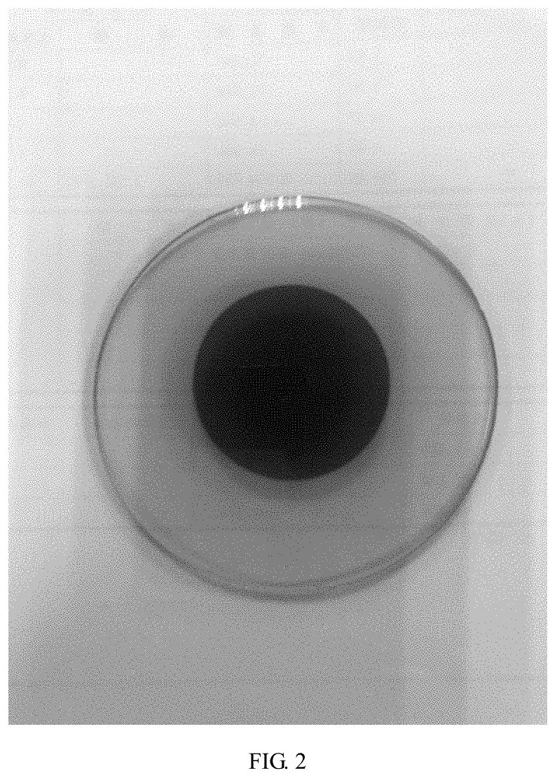

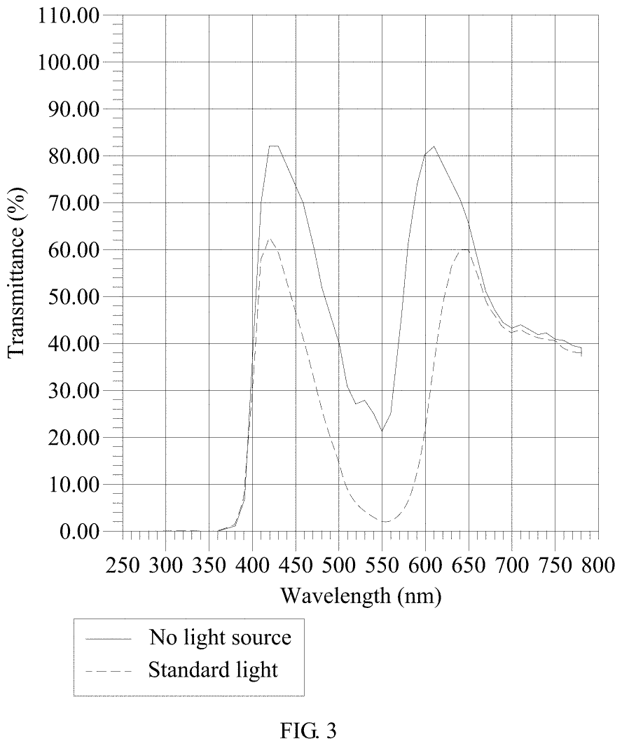

Specifically, Example 4 including a blue photochromic material is selected, and the standard ANSI Z80.3: 2018 test, EN ISO 12312-1:2013 (A1: 2015) test, and AS/NZS 1067.1: 2016 test are respectively performed with the spectrometer. The testing results are shown in FIG. 2, FIG. 3, and Table 3.

Please refer to FIG. 2 which depicts an actual view of the optical lens obtained by an example of the manufacturing method of the optical lens according to the present invention. Please refer to FIG. 3, which depicts a light penetration spectrogram of an example of the manufacturing method of the optical lens according to the present invention.

TABLE 3

| | | | | |
|---|---|---|---|---|
| | Standard | | | |
| | light | No light | | |
| | (Dark- | source | Require- | |
| Items | ened) | (Faded) | ments | Results |

ANSI Z80.3: 2018 test

| | | | | |
|---|---|---|---|---|
| Luminous transmittance, Tᵥ | 12.94% | 50.02% | | Pass |
| Minimum time (Tₘᵢₙ) of | 1.87% | 24.60% | ≥10.00% | Pass |
| wavelength 475-650 nm | | | (0.2 Tᵥ) | |
| Maximum time of wavelength | 0.13% | 0.11% | ≤6.25% | Pass |
| 280-315 nm (T_{max UVB}) | | | (0.125 Tᵥ) | |
| Maximum time of wavelength | 0.00% | 0.00% | ≤50.02% | Pass |
| 315-380 nm (Tmax _{UVA}) | | | (Tᵥ) | |
| Time of 380-500 nm (T_{sb}) | 50.81% | 78.70% | | Pass |

EN ISO 12312-1: 2013(A1: 2015) test

| | | | | |
|---|---|---|---|---|
| Luminous Transmittance, Tᵥ | 12.94% | 50.02% | | Pass |
| Minimum time (Tₘᵢₙ) of | 1.87% | 24.60% | ≥10.00% | Pass |
| wavelength 475-650 nm | | | (0.2 Tᵥ) | |
| Maximum time of wavelength | 0.00% | 0.00% | ≤2.5% | Pass |
| 280-315 nm (T_{s UVB}) | | | (0.05 Tᵥ) | |
| Maximum time of wavelength | 0.13% | 0.10% | ≤50.02% | Pass |
| 315-380 nm (T_{s UVA}) | | | (Tᵥ) | |
| Maximum time of wavelength | 0.08% | 0.07% | | |
| 280-380 nm (T_{s UV}) | | | | |
| Time of 380-500 nm (T_{sb}) | 50.81% | 78.70% | | Pass |

AS/NZS 1067.1: 2016 test

| | | | | |
|---|---|---|---|---|
| Luminous Transmittance, Tᵥ | 12.94% | 50.02% | 43%-80% | Pass |
| Minimum time (Tₘᵢₙ) of | 1.87% | 24.60% | ≥10.00% | Pass |
| wavelength 475-650 nm | | | (0.2 Tᵥ) | |
| Maximum time of wavelength | 0.00% | 0.00% | ≤2.5% | Pass |
| 280-315 nm (T_{s UVB}) | | | (0.05 Tᵥ) | |
| Maximum time of wavelength | 1.55% | 1.57% | ≤50.02% | Pass |
| 315-380 nm (T_{s UVA}) | | | (Tᵥ) | |
| Maximum time of wavelength | 0.08% | 0.07% | | |
| 280-380 nm (T_{s UV}) | | | | |
| Time of 380-500 nm (T_{sb}) | 50.81% | 78.70% | | Pass |

As shown in FIG. 2, a central portion of the optical lens refers to a state when the standard light is illuminated, which is shown in dark blue, indicating lower luminous transmittance; a circumferential portion of the optical lens refers to a state when no light source is illuminated, which is shown as transparent, indicating higher light transmittance. As shown in FIG. 3 together with Table 3, from the state of no light source to the state of standard light, the luminous transmittance changes from 50.02% to 12.94%, indicating the actual decrease in the luminous transmittance. Hence, it is known that the optical lens of the present invention indeed has the effect of photochromism. In addition, the phenomenon of the decreased luminous transmittance generated from the state of no light source to the state of standard light is suitable for manufacturing lenses for sunglasses.

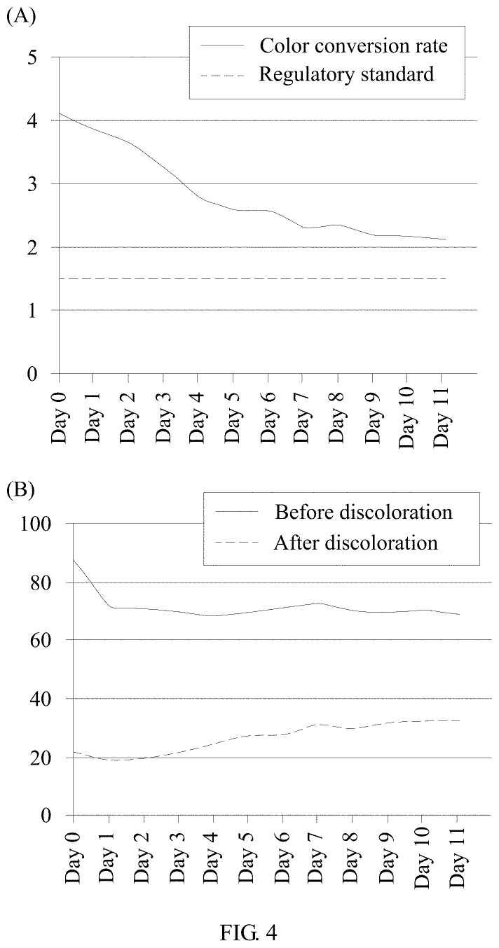

Following the aforementioned statement, the standard VP87 UV lamp illumination test is performed, and the test result is shown in FIG. 4. Wherein, the optical lens is illuminated by UV lamp illuminating for one day means that the optical lens is used for one month in a normal daily manner.

Please refer to FIG. 4, which depicts a time-maintaining analytical graph of an example of the manufacturing method of the optical lens according to the present invention. Part (A) of FIG. 4 refers to an analytical graph of the color conversion rate and the regulatory standard for different numbers of days, and part (B) of FIG. 4 refers to an analytical graph of before and after discoloration for different numbers of days. As shown, it is known that the optical lens of the present invention still has a color conversion rate which complies the regulatory standard after illuminating the UV lamp for 11 days. Therefore, the optical lens of the present invention may maintain the effect of discoloration for at least 11 months or longer in daily life.

The parameters between the tests are the same except that the added ratios are different from those of the functional materials, which thus may not be described.

Anti-Fogging Test

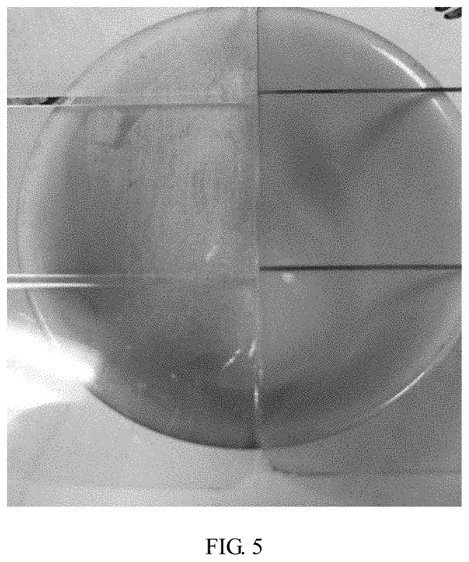

The compositions and analytical results of Examples 1 and 2 and the comparative example of Aspect 2 are shown in Tables 4 and FIG. 5. Wherein, Example 2 is an optical lens formed of compositions including 1000 g of the polymer mixture and 100 g of the anti-fogging material and molded with injection molding at 210° C. The anti-fogging material is a polyol-type non-ionic surfactant. The anti-fogging effect is tested by placing the optical lens on a beaker containing 90° C. water according to the Z87.1 standards.

TABLE 4

| | Compositions | | |
|---|---|---|---|
| | Polymer | Anti-fogging | |
| Aspect 2 | mixture | material | Results |
| Example 1 | 1000 g | X | No anti-fogging |
| | | | effect |
| Example 2 | 1000 g | 100 g | No fog in 10 |
| | | | seconds |

| | | |
|---|---|---|
| (Comparative example) | Polycarbonate anti- | No fog in 8 |
| Commercially | fogging lens processed | seconds |
| available products | by immersion plating | |

Please refer to FIG. 5, which depicts an anti-fogging test image of an example of the manufacturing method of the optical lens according to the present invention, wherein the lens on the left is a commercial product used as the comparative example, while the lens on the right is Example 2 of the present invention. Furthermore, together with Table 4, it is known that the optical lens obtained from the manufacturing method for the optical lens of the present invention indeed has an anti-fogging effect.

In addition, the action mechanism of the anti-fogging agent may cause by the special molecular structure of the polyol-type non-ionic surfactant. That is, a portion of the polyol-type non-ionic surfactant is a hydrophilic group and another portion of the polyol-type non-ionic surfactant is a lipophilic group. The hydrophilic group adsorbs water molecules in the air and reduces the surface tension, thus reducing the contact angle between water molecules and a surface of a transparent object. This enables the water molecules to wet and diffuse on the surface of the transparent object before forming small droplets on the surface of the transparent object, in order to form an very thin transparent water film. The transparent water film makes no scattering action of the incident light, and the sight of user does not interfere, thus having an anti-fogging action. For the present invention, after adding internal anti-fogging agent to the polymer mixture including the styrene-butadiene copolymer, the internal anti-fogging agent may move to the surface of the optical lens obtained by the polymer mixture. After the performance of an abrasive loss test by a rinsing machine, it is known that after the internal anti-fogging agent on the surface of the optical lens is lost by abrasion, the anti-fogging agent in the polymer mixture is moved to the surface of the optical lens again for replenishment until all of the contained anti-fogging agents is exhausted. Therefore, the feature of long anti-fogging performance may be maintained.

Hardening Test

The compositions and analytical results of Examples 1 to 4 and the comparative example of Aspect 3 are shown in Table 5. Wherein, Examples 2 to 4 are optical lenses formed of compositions including 1000 g of the polymer mixture and respectively including 1-5 g, 50-100 g, and 100-150 g of the hardening materials and molded with injection molding at 210° C. The hardening material is polytetrafluoroethylene.

TABLE 5

| | Compositions | | |
|---|---|---|---|
| | Polymer | Anti-fogging | |
| Aspect 3 | mixture | material | Results |
| Example 1 | 1000 g | X | Surface hardness 1 b |
| Example 2 | 1000 g | 1-5 g | Surface hardness 1 hb |
| Example 3 | 1000 g | 50-100 g | Surface hardness 1.5 hb |
| Example 4 | 1000 g | 100-150 g | Surface hardness 1 h |

| | | |
|---|---|---|
| Comparative example | Polycarbonate | Surface hardness 1 h |
| (Commercially | hardened lens | |
| available products) | processed by | |
| | immersion plating | |

Please refer to Table 5. It is known that the optical lens obtained by the manufacturing method of the optical lens of the present invention indeed has an effect of enhancing the surface hardness.

In short, the optical lens obtained by using the manufacturing method of the optical lens and the optical lens composition of the present invention has an adjustable function in a simple manufacturing process of injection molding. Therefore, in addition to obtaining an optical lens having the same or better function compared to commercially available products, production costs can be greatly reduced.

The above description is merely illustrative rather than restrictive. Any equivalent modification or alteration without departing from the spirit and scope of the present invention should be included in the present claims.

What is claimed is:

1. A manufacturing method of an optical lens, comprising:
molding an optical lens composition by injection molding, and the optical lens composition comprising:
a polymer mixture; and
a functional material;
wherein the polymer mixture comprises a styrene-butadiene copolymer;
wherein the styrene-butadiene copolymer accounts for at least 50 wt % of a total weight of the polymer mixture.

2. The manufacturing method according to claim 1, wherein a weight ratio of styrene to butadiene of the styrene-butadiene copolymer is 30-65:25-50.

3. The manufacturing method according to claim 1, wherein the functional material comprises a photochromic material, an anti-fogging material, a hardening material, or a combination thereof.

4. The manufacturing method according to claim 3, wherein when the functional material comprises the photochromic material, a weight ratio of the polymer mixture to the photochromic material is 1000:0.01-50.

5. The manufacturing method according to claim 3, wherein when the functional material comprises the anti-fogging material, a weight ratio of the polymer mixture to the anti-fogging material is 1000:10-200.

6. The manufacturing method according to claim 3, wherein when the functional material comprises the hardening material, a weight ratio of the polymer mixture to the hardening material is 1000:10-200.

7. An optical lens composition, comprising:
a polymer mixture; and
a functional material;
wherein the polymer mixture comprises a styrene-butadiene copolymer;
wherein the styrene-butadiene copolymer accounts for at least 50 wt % of a total weight of the polymer mixture.
